(19) United States
(12) Patent Application Publication
(10) Pub. No.: US 2011/0202655 A1
(43) Pub. Date: Aug. 18, 2011

(54) Data Center Manager

(76) Inventors: Ratnesh K. Sharma, Union City, CA (US); Chandrakant Patel, Fremont, CA (US)

(21) Appl. No.: 13/126,740

(22) PCT Filed: Oct. 28, 2008
(86) PCT No.: PCT/US2008/081464

§ 371 Date: Apr. 28, 2011

(51) Int. Cl. G06F 15/173

(52) U.S. Cl. 709/224

(57) ABSTRACT

A computer-implemented data center manager includes an evaluation engine configured to receive information pertaining to an operating policy, a system manager configured to collect information pertaining to system devices and to communicate the collected system device information to the evaluation engine, and a facility manager configured to collect information pertaining to facility devices and to communicate the collected facility device information to the evaluation engine. The evaluation engine is configured to determine target policies for coordinated operations of the system devices and the facility devices to satisfy the operating policy.

### CROSS-REFERENCES

The present application has the same Assignee and shares some common subject matter with U.S. Provisional Patent Application Ser. No. 60/989,335 (Attorney Docket No. 200702605-1), filed on Nov. 20, 2007, the disclosure of which is hereby incorporated by reference in its entirety.

### BACKGROUND

Managing data center maintenance and management costs is lucrative for businesses owning or operating data centers. The total cost of ownership (TCO) of an industry standard rack comprised of 42 1U servers aggregating to 13 KW is approximately $15,000 per month in a given data center. This TCO is astronomical, especially for information technology (IT) services in emerging markets. In order to achieve a significant reduction of the TCO, the cost components that drive physical design and data center management costs must be reduced. These cost components include costs associated with space, power, cooling, IT hardware, amortization and maintenance of facility power and cooling equipment, and operations processes for coordinating IT and facilities.

Current data center management tools are fragmented because they lack a unified synthesis and management system to enable a customer to integrate compute and facility hardware and software to meet TCO goals by minimizing component cost, assessing and ensuring reliability at a given uptime.

It would thus be beneficial to have a data center management tool that operates the data center IT and facilities components to meet TCO or other goals.

### BRIEF DESCRIPTION OF DRAWINGS

The embodiments of the invention will be described in detail in the following description with reference to the following figures.

FIG. 1 illustrates a block diagram of a computer-implemented data center manager, according to an embodiment of the invention;

FIG. 2 illustrates a block diagram of a data center synthesizer, according to an embodiment of the invention;

FIG. 3 illustrates a flow diagram of a method for managing a data center with a computer-implemented data center manager, according to an embodiment of the invention; and

FIG. 4 illustrates a block diagram of a computing apparatus configured to implement or execute the method depicted in FIG. 3, according to an embodiment of the invention.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Disclosed herein is a computer-implemented data center manager configured to meet design target objectives in the data center while substantially simplifying operations processes. Also disclosed herein is a method for managing a data center with the computer-implemented data center manager and a computer-readable storage medium on which the method is embedded. In one regard, the data center manager is able to achieve a

Through implementation of the data center manager and method disclosed herein, a TCO or other policy goal may be satisfied through a solution that is coordinated for both IT system device as well as facility devices.

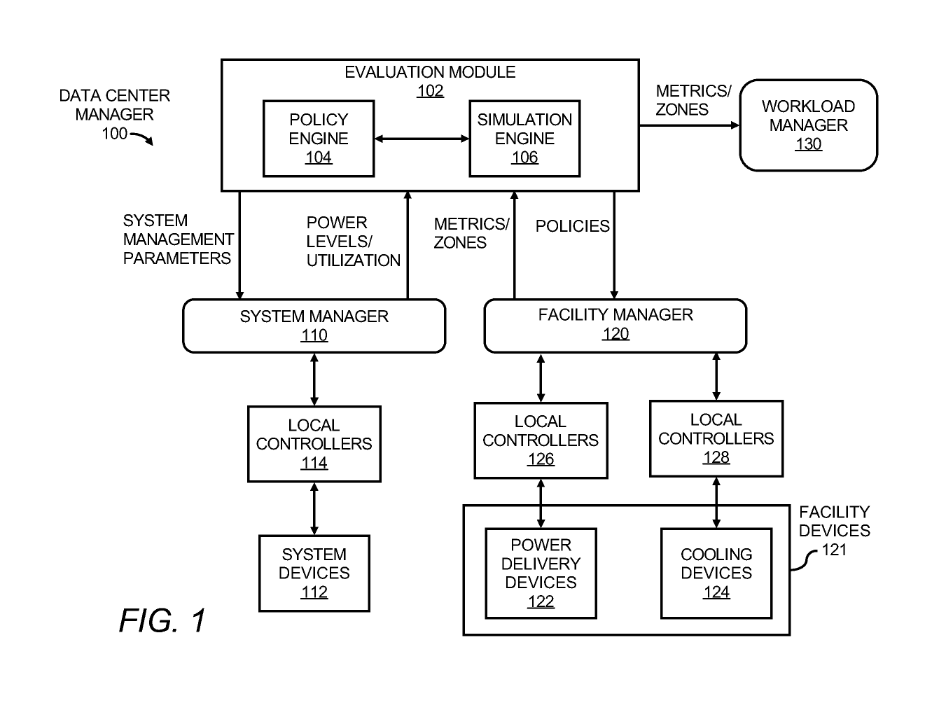

With reference first to FIG. 1, there is shown a block diagram of a computer-implemented data center manager 100, according to an example. It should be understood that the data center manager 100 may include additional elements and that some of the elements described herein may be removed and/or modified without departing from a scope of the data center manger 100.

Generally speaking, the data center manager 100 is configured to coordinate the operations of disparate management tools, which include various system devices 112 and facility devices 121 to meet one or more operating policy objectives. The one or more operating policy objectives may include, for instance, maintaining a desired level of availability, maintaining a desired total cost of ownership (TCO), and other provisions as may be set forth by a customer in a service level agreement with the data center owner or operator.

As shown in FIG. 1, the data center manager 100 includes an evaluation engine 102, a system manager 110, and a facility manager 120. In certain embodiments, the data center manager 100 also includes a workload manager 130. In other embodiments, the system manager 110 is configured to perform the operations of the workload manager 130 or the workload manager 130 comprises a component separate from the data center manager 100.

The evaluation engine 102 includes a policy engine 104 and a simulation engine 106. The policy engine 104 is configured to receive the operating policy information, for instance, from a user, a database, or other source containing the operating policy information. The policy engine 104 is also configured to translate the operating policy information into a language that the simulation engine 106 understands and to communicate the translated operating policy information to the simulation engine 106.

The simulation engine 106 also receives information from the system manger 110 pertaining to the system devices 112 and information from the facility manager 120 pertaining to the facility devices 121. The system devices 112 include, for instance, storage devices, network devices, compute devices, thermal management devices, power management devices, etc. The system manager 110 collects information pertaining to the current utilization levels of the system devices 121. In addition, or alternatively, the system manager 110 collects information pertaining to the power levels at which the system devices 121 are currently operating. In either example, the system manager 110 communicates the collected system device information to the evaluation module 102, as indicated by the arrow labeled as “power levels/utilization”.

By way of a particular example, the system manager 110 collects information pertaining to loading on various storage devices, CPU utilization levels of various servers, bandwidth utilization of a network, etc. As another example, the system manager 110 collects information pertaining to how the power supplies of the system devices 112 are operating to determine the power levels of the system devices 112.

The facility devices 121 include power delivery devices 122 and cooling devices 124. The power delivery devices 122 include, for instance, uninterruptible power supplies (UPS), power distribution units (PDU), etc. The power delivery devices 122 may also or alternatively be in communication with the system manager 110 as they may be classified as system devices 112. The cooling devices 124 include, for instance, computer room air conditioning (CRAC) units, sensors, ventilation tiles, water chiller plants, cooling towers, etc. The facility manager 120 collects information pertaining to one or more of the utilizations, the load efficiencies, the capacities, etc., of the power delivery devices 122. The facility manager 120 also collects information (metrics) pertaining to one or more of the utilization levels, operating levels, capacity levels, energy consumption levels, etc., of the cooling devices 124.

Based upon the information received from the power delivery devices 122 and the cooling devices 124, the facility manager 120 is configured to identify one or more conditions in various zones of the data center. For instance, the facility manager 120 may identify a first type of zone as having a relatively high availability of capacity and redundancy due to that zone receiving cooling airflow from multiple air conditioning units. In addition, the facility manager 120 may identify a second type of zone as having no thermal redundancy, but with some available capacity. Furthermore, the facility manager 120 may identify a third type of zone as having no thermal redundancy and no available capacity.

The facility manager 120 communicates the metrics and zone information to the evaluation module 102 as indicated by the arrow labeled as “metrics/zones”. According to an example, the facility manager 120 communicates the “metrics/zone” information to the workload manager 130 to enable the workload manager 130 to manage placement of workloads based upon the data center's physical state. By way of particular example, when a particular CRAC unit is being serviced, the evaluation module will cap the power levels for those system devices 112 contained in the zone affected by the CRAC unit and thus, the workload manager 130 ensures that no new workloads are deployed in that zone during the servicing period.

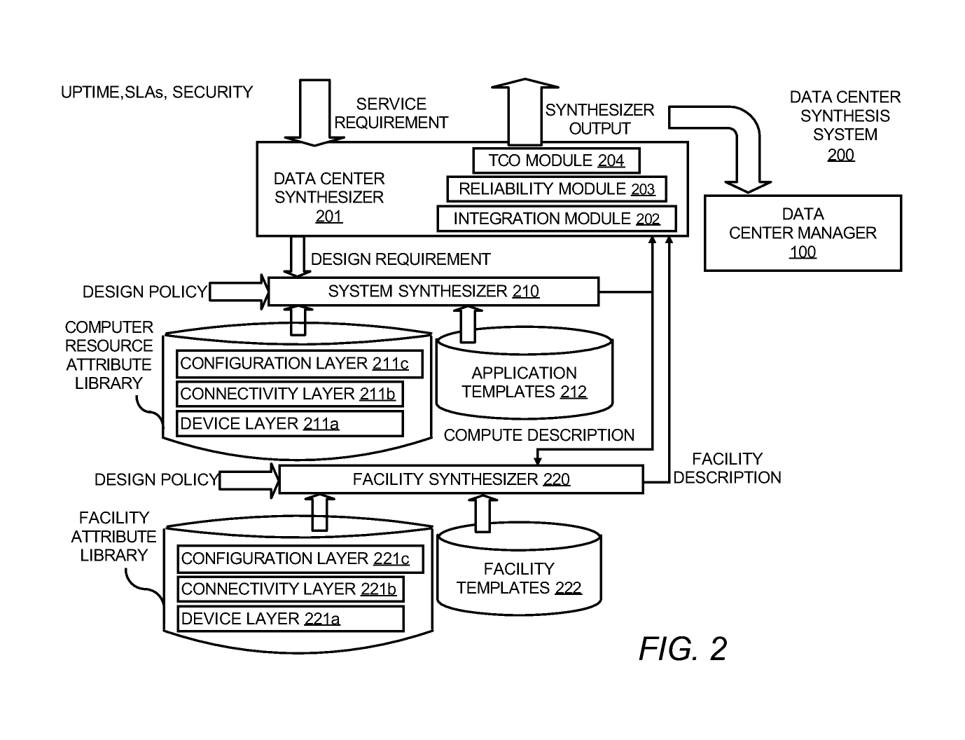

The simulation engine 106 is configured to perform simulations, such as, Monte Carlo or the like simulations, based upon the information received from the policy engine 104, the system manager 110, and the facility manager 120. More particularly, the simulation engine 106 is configured to perform the simulations on virtual representations of the system devices 112 and the facility devices 121. According to an example, the virtual representations of the system devices 112 and the facility devices 121 are created through operation of a data center synthesizer system 200 depicted in FIG. 2. The components and operations of the data center synthesizer system 200 are described in greater detail in copending U.S. Provisional Patent Application Ser. No. 60/989,335 (Attorney Docket No. 200702605-1), the disclosure of which is hereby incorporated by reference in its entirety. As such, only a brief discussion of the data center synthesizer system 200 will be provided herein.

In one respect, the data center synthesis system 200 uses system and facility models to design a data center based on initial service requirements and design policies. The data center synthesis system 200 comprises a data center synthesizer 201, a system synthesizer 210 and a facility synthesizer 220.

The data center synthesizer 210 translates service requirements to design requirements which lays the framework for the system synthesizer 210. The system synthesizer 210 uses a computer resource attribute library 211 and application templates 212 to generate a compute description based on the design requirements and computer resource design policies. The computer resource attribute library 211 describes features of computer resources that can be used in the data center. In particular, the library 211 may include a device layer 211a, a connectivity layer 211b and a configuration layer 211c. The application templates 212 include a library of templates providing accumulated knowledge regarding typical system designs for common service specifications.

The system synthesizer 210 performs a series of design space walks and design evaluations resulting in a candidate compute design description. The compute description specifies the computer resources to be used in the data center, their required interconnections, and their operating loads. The computer resources include the hardware and software to be used for running workloads in the data center. For example, the system synthesizer 210 receives the design requirements, which may be low level metrics translated from SLAs, such as compute capacity, storage capacity, network capacity, etc. The system synthesizer 210 identifies components from the models in the library 211 and/or the templates 212 that satisfy the design requirements. These selected computer resources, their required interconnections, and their operating loads are described in the compute description.

The compute description created by the system synthesizer 210 may be used to drive the generation of the facility description created by the facility synthesizer 220. The facility synthesizer 220 uses a facility attribute library 221, facility templates 222, design requirements and policies to generate the facility description describing the facilities to be used with the computer resources in the data center.

The facility attribute library 221 describes features of facilities that support the computer resources in the data center. The facility attribute library 221 includes a device layer 221a, a connectivity layer 221b and a configuration layer 221c.

The facility synthesizer 220 uses the facility attribute library 221 and the facility templates 222 to generate the facility description, similar to the system synthesizer 210 generating the compute description. However, the facility synthesizer 220 also uses the compute description generated by the system synthesizer 220 to select components for the facilities from the library 221 and/or the templates 222. The facilities may include subsystems that support the computer resources and other systems described in the compute description. Thus, the compute description is used to select components for the facilities.

The facility synthesizer 220 performs a series of design space walks and design evaluations resulting in a candidate facility description. The facility description specifies the facilities, their required interconnections, and their operating loads. Also, design policies may be considered when selecting the components. For example, policies concerning efficiency may be used to determine the amount of over-provisioning that is acceptable.

The data center synthesizer 201 includes an integration module 202, a reliability module 203 and a TCO module 204. The facility description and the compute description are sent to the data center synthesizer 201. The integration module 202 integrates the facility and system designs described by the facility description and the compute description.

The facility and system designs integrated by the integration module 202 are evaluated for reliability by the reliability module 203. The integrated facility and system designs are referred to as an integrated view or an integrated system.

The output of the data center synthesizer 201 may comprise a virtual representation of the system devices 112 and the facility devices 121 contained in a data center. In addition, the virtual representation may be outputted to the data center manager 100.

Although particular reference has been made to the virtual representation of the system devices 112 and the facility devices 121 being created by the data center synthesizer 201 depicted in FIG. 2, it should be understood that the virtual representation of the system devices 112 and the facility devices 121 may be created through other means without departing from a scope of the data center manager 100.

In any event, the simulation engine 106 performs simulations for a number of virtual workloads based upon the virtual representations of the system devices 110 and the facility devices 121, as well as the information pertaining to the system devices 110 and the facility devices 121 received from the system manager 110 and the facility manager 120. In one regard, the simulation engine 106 is configured to determine whether the system devices 112 and the facility devices 121 are likely to meet the desired operating policies as defined in the translated operating policy information. The simulation engine 106 may further be configured to determine target policies for coordinated operations of the system devices 112 and the facility devices 121 based upon the one or more simulations that result in the operating policy being met.

By way of particular example, the policy engine 104 receives policy information pertaining to a customer request that an application run at a predefined availability level of a certain number of users, for a certain number of hours every year, with a certain latency. The policy information received pertaining to customer requests are typically not specified in terms of language that the simulation engine 106 is able to understand. Instead, the policy information specifies the guidelines of the operation in performing the application. The policy engine 104 thus translates those guidelines into a language that the simulation engine 106 may understand. For instance, the policy engine 104 may translate what it means to have a predefined level of availability into terms that the simulation engine 106 will understand. As another example, the policy engine 104 may translate the operating policy into whether redundant cooling zones and/or power supplies should be provided in the data center.

The simulation engine 106 is configured to simulate the whole process of the data center operation in a virtual environment to determine whether necessary benchmarks of the translated operating policy information are being met or not. In one example, the simulation engine 106 performs simulations based upon random workloads to determine whether the operating policies, for instance, defined in one or more SLAs, are being met. The simulation engine 106 may also identify which of the simulations of system devices 112 and facility devices 121 yield minimized resource consumption and/or TCO in the data center. The simulation engine 106 may further identify the TCO for a simulation that results in the operating policies being met.

The simulation engine 106 may determine target policies that are to be met at the system level and the facility level that meet the desired operational policies. In this regard, the simulation engine 106 communicates the target policies to the system manager 110 as shown by the arrow labeled as “system management parameters” and the facility manager 120 as shown by the arrow labeled as “policies”. The target policies generally comprise policies that the system manager 110 and the facility manager 120 seek to enforce in the system devices 112 and the facility devices 121.

By way of particular example, if an operational policy is to maintain a predefined level of availability, the simulation engine 106 may determine the temperatures at which one or more air conditioning units should be operating at in or order to maintain the predefined level of availability. In this example, the target policies may include the determined temperatures. As another example, the simulation engine 106 may determine the necessary CPU utilization levels of the compute systems to maintain the predefined level of availability. In this example, the target policies may include the necessary CPU utilization levels determined to maintain the predefined level of availability.

The system manager 110 and the facility manager 120 translate the target policies into actions that respective local controllers 114, 126, 128 are configured to implement in the system devices 112 and the facility devices 121. The local controllers 114, 126, 128 generally comprise controllers that are configured with the ability to implement the actions translated from the target policies. The local controllers 114, 128, 128 may thus comprise controllers for particular system devices 112, power delivery devices 122, and cooling devices 124. In one regard, the system manager 110 communicates the actions to the local controllers 114, which controls the system devices 112 and the facility devices 121 because in many instances the system manager 110 will not have the correct tools to cause the system devices 112 or the facility devices 121 to perform the actions.

By way of particular example, the simulation engine 106 may inform the system manager 110 that a particular compute device is to have a certain utilization level, the system manager 110 may be unable to force the utilization level onto that compute device because the system manager 110 does not have the correct programming and/or interfaces to cause the compute device to operate at the desired utilization level. Instead, therefore, the system manger 110 may provide the target utilization level as a cap to the local controller 114, which may comprise, in this instance, a controller of the compute device. In addition, the local controller 114 may operate the compute device to meet the target utilization level.

As another particular example, the simulation engine 106 may inform the system manager 110 that a particular network device is to have a certain bandwidth utilization level. Similar to the example above, the simulation engine 106 may be unable to force the bandwidth utilization level on the network device because the system manager 110 does not have the correct programming and/or interfaces to cause the network device to operate at the desired bandwidth utilization level. Instead, therefore, the system manger 110 may provide the target bandwidth utilization level as a cap to the local controller 114, which may comprise, in this instance, a controller of the network device. In addition, the local controller 114 may operate the network device to meet the target utilization level.

The components of the data center manager 100 comprise software, firmware, hardware, or a combination thereof. Thus, for instance, one or more of the policy engine 104, simulation engine 106, system manager 110, facility manager 120, and workload manager 130 may comprise software modules stored on one or more computer readable media. Alternatively, one or more of the policy engine 104, simulation engine 106, system manager 110, facility manager 120, and workload manager 130 may comprise one or more hardware modules, such as circuits, or other devices configured to perform the functions of the evaluation engine 102, system manager 110, facility manager 120, and workload manager 130 as described above.

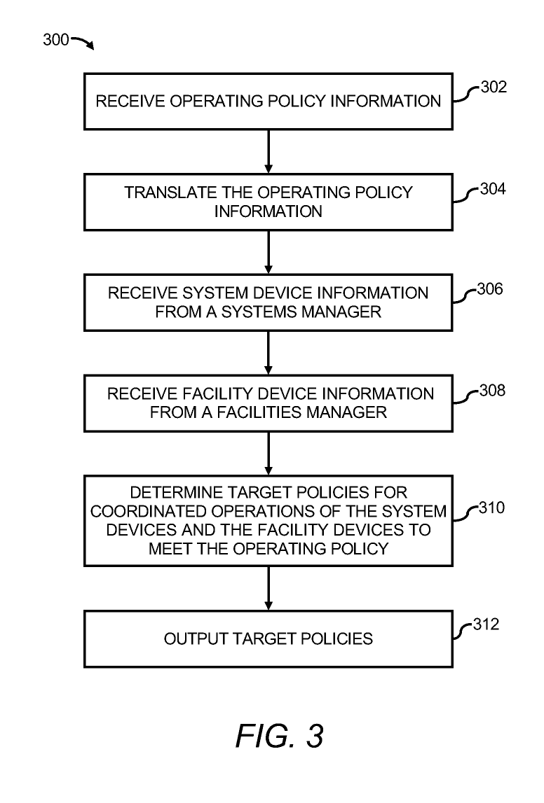

An example of a method of managing a data center with a computer-implemented data center manager 100 will now be described with respect to the following flow diagram of the method 300 depicted in FIG. 3. It should be apparent to those of ordinary skill in the art that the method 300 represents a generalized illustration and that other steps may be added or existing steps may be removed, modified or rearranged without departing from a scope of the method 300.

The description of the method 300 is made with reference to the data center manager 100 illustrated in FIG. 1, and thus makes reference to the elements cited therein. It should, however, be understood that the method 300 is not limited to the elements set forth in the data center manager 100. Instead, it should be understood that the method 300 may be practiced by a system having a different configuration than that set forth in the data center manager 100.

FIG. 3 depicts a flow diagram of a method 300 for managing a data center with a computer-implemented data center manager 100, according to an example. At step 302, the policy engine 104 receives information pertaining to an operating policy. The policy engine 104 may receive the operating policy information from a user through a user interface, from a data storage location, etc. In addition, the operating policy may include, for instance, a goal of maintaining a desired level of availability, maintaining a desired level of total cost of ownership (TCO), and other provisions as set forth by a customer in a service level agreement with the data center owner or operator.

At step 304, the policy engine 104 translates the operating policy information into a language that the service operator 106 understands. For example, the policy engine 104 translates guidelines associated with the operating policy information into terms that the simulation engine 106 will understand in performing one or more simulations.

At step 306, the evaluation engine 102, and more particularly, the simulation engine 106, receives information pertaining to the system devices 112 from the system manager 110. By way of example, the system device information may include the power levels and/or the utilization levels of the system devices 112. In addition, at step 308, the policy engine 102, and more particularly, the simulation engine 106 receives information pertaining to the facility devices 121 from the facility manager 120. By way of example, the facility device information includes metrics pertaining to capacity levels, utilization levels, etc., of the facility devices 121. The facility device information may also include various zones in the data center that may be characterized differently from each other depending upon, for instance, the available capacities and the level of redundancies available in the various zones.

At step 310, the simulation engine 106 determines target policies for coordinated operations of the system devices 112 and the facility devices 121 to meet the operating policy. More particularly, for instance, the simulation engine 106 performs simulations on virtual representations of the system devices 112 and the facility devices 121 to determine whether the target policies are likely to meet the desired operating policies as contained in the translated operating policy information. By way of example, the simulation engine 106 may simulate how the operating policy is affected when various target policies for the system devices 112 and the facility devices 121 are instated.

In addition, or alternatively, the simulation engine 106 may determine which of a plurality of different simulations result in desired operating policies being met and to calculate the total cost of ownership associated with each of the plurality of different simulations. In this example, the simulation engine 106 may also select the target policies from the simulation of the plurality of different simulations that results in a lowest total cost of ownership.

At step 312, the simulation engine 106 outputs the target policies determined at step 310. In a first example, the simulation engine 106 outputs the target policies relating to the system devices 112 to the system manager 110 and outputs the target policies relating to the facility devices 121 to the facility manager 120. In this example, the system manager 110 interprets the target policies as target utilization levels for one or more of the system devices 112. In addition, the facility manager 120 interprets the target policies as target utilization levels for one or more of the facility devices 121. Moreover, the system manager 110 and the facility manager 120 communicate the target utilization levels to respective local controllers 114, 126, 128 configured to control the one or more system devices 112 and the one or more facility devices 121.

In another example, the simulation engine 106 outputs the target policies to one or more outputs, such as, a display, a data store, a network connection to another computing device, etc. In this example, the target utilization levels determined by the simulation engine 106 may be used as an evaluation tool instead of, or in addition to, as a control tool in the data center.

As may be seen from the method 300, the evaluation module 102 generally operates to enable evaluation and/or control of data center system and facility devices, such that, the system devices and the facility devices may be operated at target utilization levels that meet operating policies, for instance, as set forth in one or more service level agreements.

The operations set forth in the method 300 may be contained as a utility, program, or subprogram, in any desired computer accessible medium. In addition, the method 300 may be embodied by a computer program, which may exist in a variety of forms both active and inactive. For example, the computer program may exist as software program(s) comprised of program instructions in source code, object code, executable code or other formats. Any of the above may be embodied on a computer readable medium.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

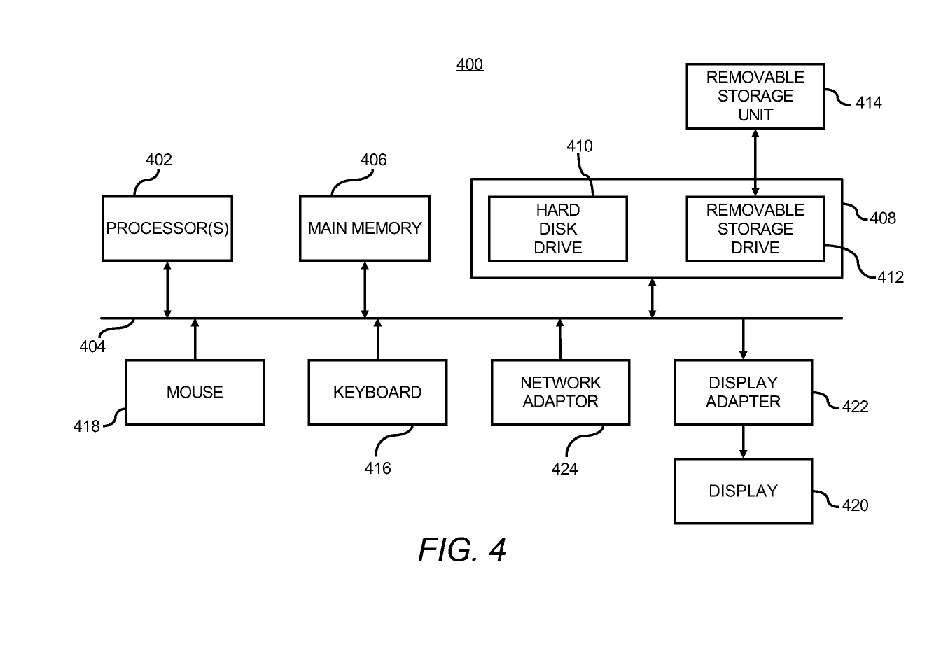

FIG. 4 illustrates a block diagram of a computing apparatus 400 configured to implement or execute the method 300 depicted in FIG. 3, according to an example. In this respect, the computing apparatus 400 may be used as a platform for executing one or more of the functions described hereinabove with respect to one or more of the policy engine 104, the simulation engine 106, the system manager 110, and the facility manager 120 depicted in FIG. 1.

The computing apparatus 400 includes a processor 402 that may implement or execute some or all of the steps described in the method 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the method 300 may be stored.

The removable storage drive 412 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A computer-implemented data center manager comprising:
an evaluation engine configured to receive information pertaining to an operating policy;
a system manager configured to collect information pertaining to system devices and to communicate the collected system device information to the evaluation engine;
a facility manager configured to collect information pertaining to facility devices and to communicate the collected facility device information to the evaluation engine; and
wherein the evaluation engine is configured to determine target policies for coordinated operations of the system devices and the facility devices to satisfy the operating policy.

2. The computer-implemented data center manager according to claim 1, wherein the evaluation engine includes a policy engine and a simulation engine, wherein the policy engine is configured to translate the operating policy information into a language that the simulation engine understands and wherein the simulation engine is configured to perform simulations on virtual representations of the system devices and the facility devices to determine whether the target policies are likely to meet desired operating policies as contained in the translated operating policy information.

3. The computer-implemented data center manager according to claim 2, wherein the simulation engine is configured to determine the target policies for coordinated operations of the system devices and the facility devices from the one or more simulations that result in the operating policy being met.

4. The computer-implemented data center manager according to claim 3, wherein the simulation engine is further configured to calculate a total cost of ownership associated with each of a plurality of different simulations and to select the target policies from the simulation of the plurality of different simulations that results in a substantially lowest total cost of ownership.

5. The computer-implemented data center manager according to claim 1, wherein the evaluation engine is further configured to output the target policies to the facility manager and the system manager, and wherein the system manager is configured to interpret the target policies as target utilization levels for one or more of the system devices and wherein the facility manager is configured to interpret the target policies as target utilization levels for one or more of the facility devices.

6. The computer-implemented data center manager according to claim 5, wherein the system manager is in communication with at least one local controller configured to control the one or more system devices, and wherein the system manager is further configured to communicate the target utilization levels for the one or more system devices to the local controller.

7. The computer-implemented data center manager according to claim 5, wherein the facility manager is in communication with at least one local controller configured to control one or more of the facility devices, and wherein the facility manager is further configured to communicate the target utilization levels for the one or more facility devices to the local controller.

8. The computer-implemented data center manager according to claim 1, wherein the facility manager is further configured to collect information pertaining to multiple zones in the data center, wherein the facility manager is configured to identify the multiple zones based upon at least one of facility device capacity availability and redundancy.

9. A method for managing a data center with a computer-implemented data center manager, said method comprising:
receiving information pertaining to an operating policy;
receiving system device information from a systems manager;
receiving facility device information from a facility manager;
determining target policies for coordinated operations of the system devices and the facility devices to meet the operating policy; and
outputting the determined target policies.

10. The method according to claim 9, wherein the computer-implemented data center manager comprises a policy engine and a simulation engine, said method further comprising:
in the policy engine, translating the operating policy information into a language that the simulation engine understands; and
in the simulation engine, performing simulations on virtual representations of system devices and facility devices in the data center to determine whether the target policies are likely to meet desired operating policies as contained in the translated policy information.

11. The method according to claim 10, the method further comprising:
in the simulation engine, determining which of a plurality of different simulations result in the desired operating policies being met, calculating a total cost of ownership associated with each of the plurality of different simulations, and wherein determining the target policies further comprises selecting the target policies from the simulation of the plurality of different simulations that results in a substantially lowest total cost of ownership.

12. The method according to claim 10, wherein the computer-implemented data center manager comprises a system manager and a facility manager, said method further comprising:
in the system manager, receiving the outputted target policies relating to system devices and interpreting the target policies as target utilization levels for one or more of the system devices; and
in the facility manager, receiving the outputted target policies relating to facility devices and interpreting the target policies as target utilization levels for one or more of the facility devices.

13. The method according to claim 12, wherein the system manager is in communication with at least one local controller configured to control the one or more system devices and wherein the facility manager is in communication with at least one local controller configured to control one or more of the facility devices, said method further comprising:
in the system manager, communicating the target utilization levels for the one or more system devices to the local controller configured to control the one or more system devices; and
in the facility manager, communicating the target utilization levels for the one or more facility devices to the local controller configured to control the one or more facility devices.

14. A computer readable storage medium on which is embedded one or more computer programs, said one or more computer programs implementing a method of managing a data center with a computer-implemented data center manager, said one or more computer programs comprising a set of instructions for:
receiving information pertaining to an operating policy;
receiving system device information from a systems manager;
receiving facility device information from a facility manager;
determining target policies for coordinated operations of the system devices and the facility devices to meet the operating policy; and
outputting the determined target policies.

15. The computer readable storage medium according to claim 14, wherein the computer-implemented data center manager comprises a policy engine and a simulation engine, said one or more computer programs comprising a set of instructions for:
in the policy engine, translating the operating policy information into a language that the simulation engine understands; and
in the simulation engine, performing simulations on virtual representations of system devices and facility devices in the data center to determine whether the target policies are likely to meet desired operating policies as contained in the translated policy information.
